(19) United States
(12) Patent Application Publication
(10) Pub. No.: US 2025/0035453 A1
(43) Pub. Date: Jan. 30, 2025

(54) COMPLEX NAVIGATION MANEUVER REDUCTION

(71) Applicant: Uber Technologies, Inc., San Francisco, CA (US)

(72) Inventors: Junzhuo Chen, San Mateo, CA (US); Rade Stanojievic, Seattle, WA (US); Can Akcevin, Brooklyn, NY (US); Vineet Khosla, Pacifica, CA (US); Patrick Tsung-Ping Muh, Cupertino, CA (US); Danni Lu, Foster City, CA (US); Dehui Yang, San Francisco, CA (US); Nadia Moosvi, San Francisco, CA (US)

(21) Appl. No.: 18/359,835

(22) Filed: Jul. 26, 2023

(51) Int. Cl. G01C 21/34

(52) U.S. Cl. CPC G01C 21/3461

(57) ABSTRACT

Systems and methods herein describe a navigation system for reducing complex maneuvers in navigation instructions. The navigation system receives a transportation request comprising an origin and a destination, determines a first shortest path from the origin to the destination location, and identifies a subset of maneuvers in the first shortest path that are associated with a penalty value. The navigation system further generates a modified path value by applying the penalty value to the identified subset of maneuvers, and in response to identifying that the modified total path value exceeds a threshold value, determines a second shortest path from the origin to the destination. The navigation system generates navigation instructions comprising a second plurality of maneuvers associated with the second shortest path, and transmits the navigation instructions to a computing device.

### TECHNICAL FIELD

Embodiments herein generally relate to navigation systems. More specifically, the present disclosure addresses reducing complex navigation maneuvers in navigation instructions.

### BACKGROUND

Creating safer drivers and safer roads is a societal priority across borders. Many drivers rely on a map navigation system on a personal mobile device or a computing device integrated with a vehicle to route them from one location to another.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a network system according to example embodiments.

FIG. 2 illustrates a flowchart for a method for reducing complex maneuvers in navigation instructions, in accordance with one embodiment.

FIG. 3 is a diagrammatic representation of the machine within which instructions for causing the machine to perform any one or more of the methodologies discussed herein may be executed, according to example embodiments.

FIG. 4 is a block diagram illustrating a software architecture, which can be installed on any one or more of the devices described herein, according to example embodiments.

### DETAILED DESCRIPTION

Complex navigation maneuvers in a map navigation system lead to accident prone driving behaviors. Thus, there is a need to simplify and reduce complex navigation maneuvers to create safer roadways without negatively impacting efficiency and reliability of the navigation system.

A navigation system is disclosed herein that reduces complex navigation maneuvers. Complex navigation maneuvers may include any maneuver that is high-risk or otherwise difficult to accomplish. For example, a complex navigation maneuver may be an unprotected left turn (e.g., a left turn at an intersection without protection from a signal light or stop sign) or a U-turn on a major, high-traffic road. In some examples, a complex navigation maneuver may be a specific sequence of maneuvers such as a left turn followed by an immediate right turn, or two consecutive left turns on major, high-traffic roads. Although the above complex navigation maneuvers are provided as examples herein, it is to be understood that any difficult set of maneuvers can be considered a complex maneuver.

The navigation system identifies complex maneuvers and reduces the number of complex maneuvers provided as navigation instructions. In some examples, the navigation system is employed as part of a transportation ride-share or delivery system, and reduces the complex maneuvers without increasing travel time, costs, and travel distance.

For example, the navigation system receives a transportation request. The transportation request may be a ride-share request, a delivery request, or any request for using a vehicle to travel from an origin location to a destination location. The navigation system determines the shortest path from the origin to the destination and identifies navigation maneuvers in the shortest path that are associated with a penalty parameter and a penalty value. In some examples the penalty parameter is associated with a complex maneuver type such as an unprotected left turn, U-turn on a major, high traffic road, specific sequence of maneuvers and the like. The penalty value is a value associated with the penalty parameter. For example, the route from the origin to the destination is represented as a weighted graph. The nodes in the weighted graph are junctions and the edges are roads. Each road can be given a weight. If a road comprises a complex maneuver type, the road can be assigned a penalty value. Although the penalty value may be the weight associated with an edge of the weighted graph, there may be other parameters that influence the weight of an edge in the weighted graph, such as road class, distance, and time.

The navigation system modifies the total path value (e.g., total path weight) of the shortest path by applying the penalty value to the identified navigation maneuvers associated with a penalty parameter. If the modified total path value exceeds a predefined threshold, the navigation system determines a second shortest path from the origin to the destination. The navigation system generates navigation instructions for navigating the second shortest path and transmits the navigation instructions to a computing device. Further instructions regarding the navigation system are described below.

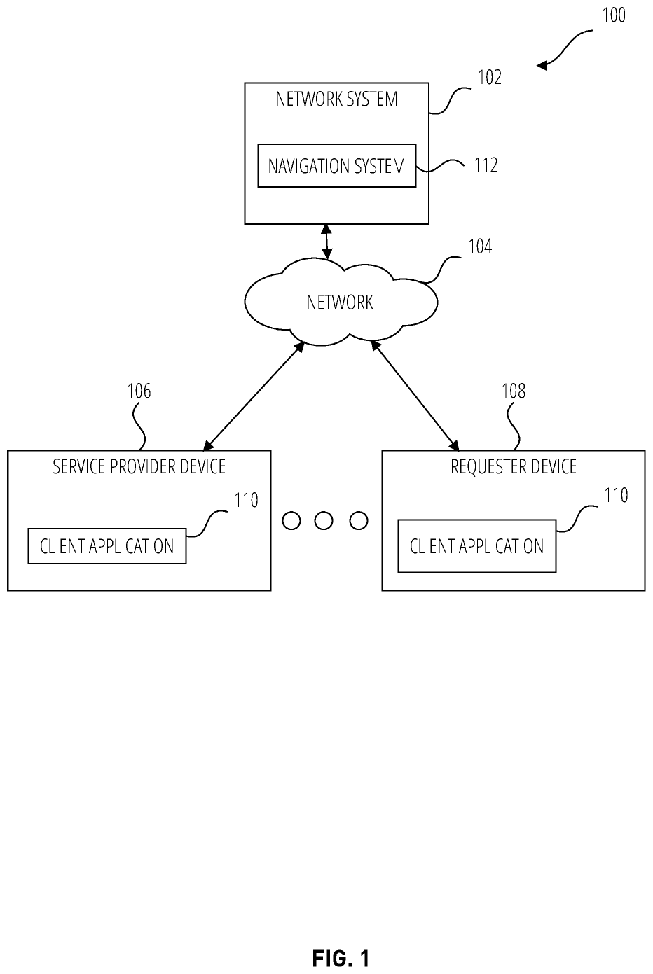

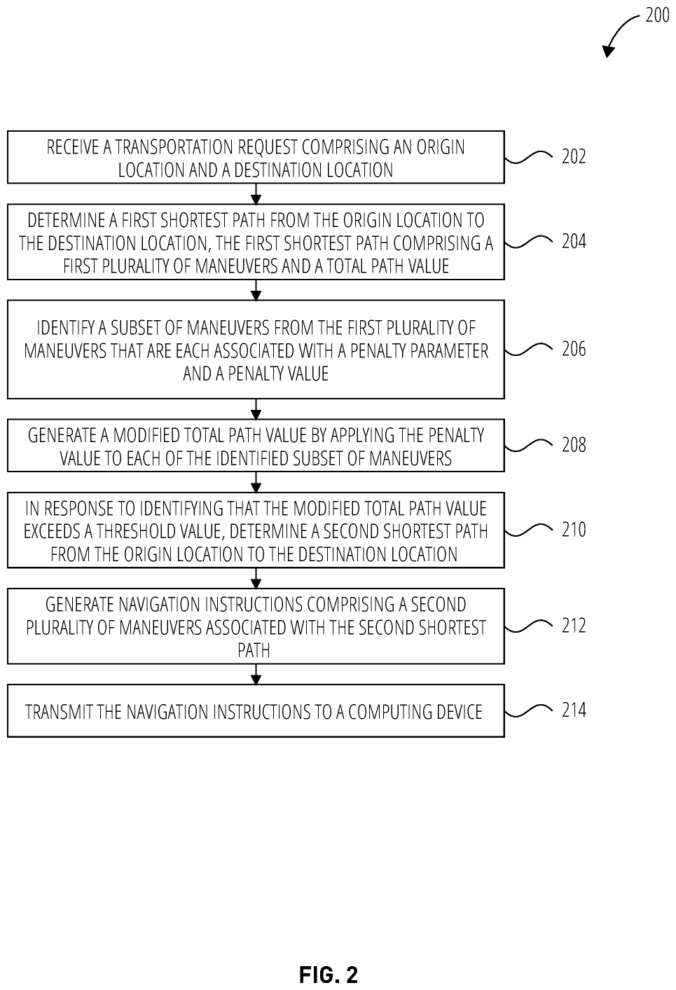

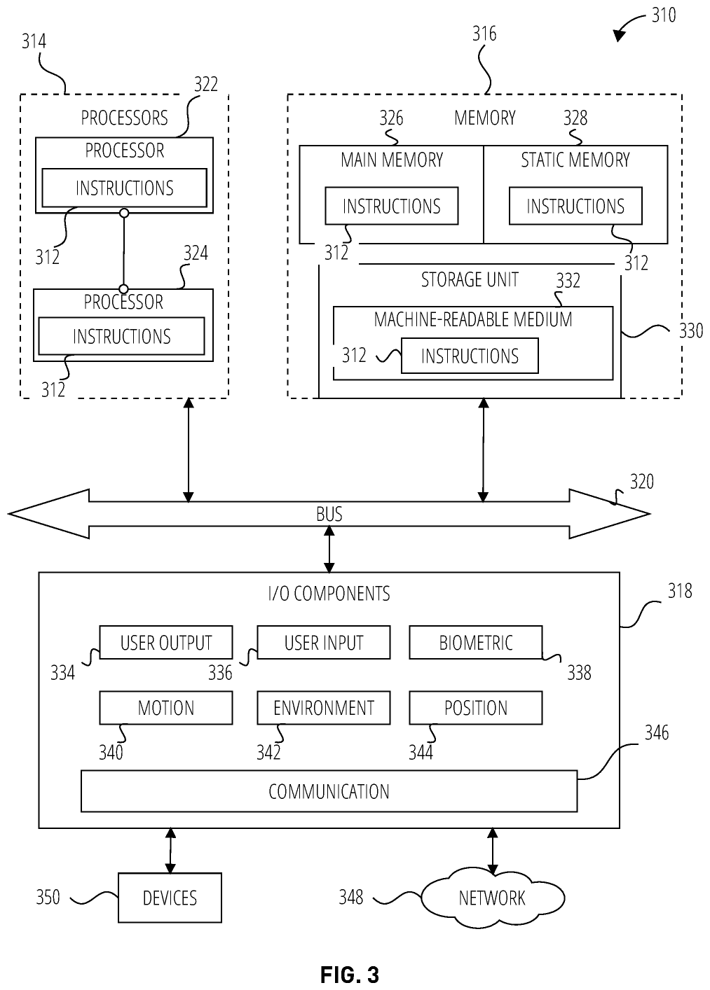

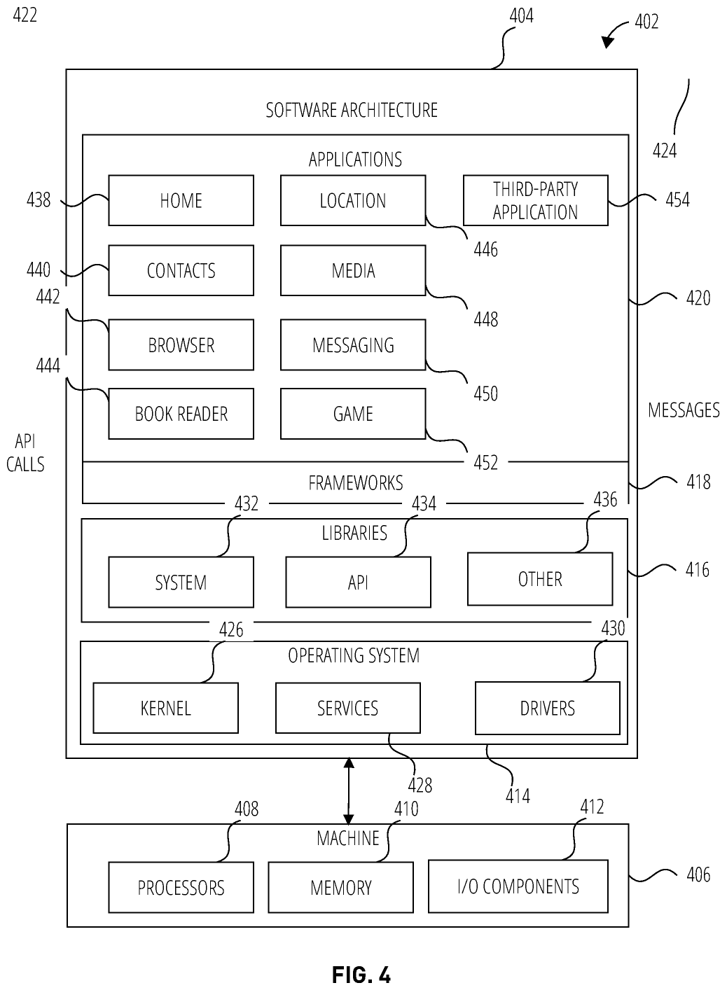

FIG. 1 is a diagram illustrating a network environment 100 suitable for providing accurate and customized search results. The network environment 100 includes a network system 102 communicatively coupled via a network 104 to a service provider device 106 of a driver or service provider and a requester device 108 of a user or requester (e.g., rider). In example embodiments, the network system 102 comprises components that obtain, store, and analyze data received from the service provider device 106 or the requester device 108 in order to determine access points. More particularly, the network system 102 performs a federated search across multiple data sources to generate accurate and customized search results based on various signals received from the service provider device 106 or the requester device 108. The components of the network system 102 are described in more detail in connection with FIG. 2 and may be implemented in a computer system, as described below with respect to FIGS. 3-4.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the service provider device 106 and the requester device 108 are portable electronic devices such as smartphones, tablet devices, wearable computing devices (e.g., smartwatches), or similar devices. Alternatively, the service provider device 106 can correspond to an on-board computing system of a vehicle. The service provider device 106 and the requester device 108 each comprises one or more processors, memory, touch screen displays, wireless networking system (e.g., IEEE 802.11), cellular telephony support (e.g., LTE/GSM/UMTS/CDMA/HSDP A), and/or location determination capabilities.

The service provider device 106 and the requester device 108 interact with the network system 102 through a client application 110 stored thereon. The client application 110 allows for exchange of information with the network system 102 via user interfaces, as well as in background. For example, the client application 110 may determine and/or provide location information of the service provider device 106 and the requester device 108 (e.g., current location in latitude and longitude), barometer readings, or signal strengths (e.g., Wi-Fi and Bluetooth signal strengths) via the network 104, for analysis and storage. In example embodiments, the location information is used by the network system 102 for generating accurate and customized search results, as will be discussed in more details below.

In example embodiments, the network system 102 includes a navigation system 112. The navigation system 112 generates navigation instructions that contain the least number of complex maneuvers within the instructions. Further details of the navigation system 112 are provided below.

In example embodiments, a first user (e.g., a requester or rider) operates the requester device 108 that executes the client application 110 to communicate with the network system 102 to make a request for a transportation service such as transport or delivery service (referred to collectively as a “trip”). In example embodiments, the client application 110 presents, via user interfaces, navigation instructions from an origin to a destination location with the least number of complex maneuvers without sacrificing factors such as cost, distance, or time traveled.

A second user (e.g., a service provider or driver) operates the service provider device 106 to execute the client application 110 that communicates with the network system 102 to exchange information associated with providing the transportation service (e.g., to the user of the requester device 108). The client application 110 presents information via user interfaces to the second user of the service provider device 106, such as invitations to provide the transportation service, navigation instructions, and pickup and drop-off locations of people or items to be transported. The client application 110 also provides data to the network system 102 such as a current location (e.g., coordinates such as latitude and longitude), associated with the service provider device 106 or vehicle.

In example embodiments, any of the systems, machines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIGS. 3-4, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of client devices (e.g., service provider device 106, requester device 108) may be embodied within the network environment 100. Furthermore, some components or functions of the network environment 100 may be combined or located elsewhere in the network environment 100. For example, some of the functions of the network system 102 may be embodied within other systems or devices of the network environment 100. Additionally, some of the functions of the client devices (e.g., service provider device 106, requester device 108) may be embodied within the network system 102. While only a single network system 102 is shown, alternative embodiments may contemplate having more than one network system 102 to perform server operations discussed herein for the network system 102.

FIG. 2 illustrates a process 200 for generating navigation instructions with a reduced number of complex maneuvers, in accordance with one example. In one example, the processor in a network system 102, the processor in a navigation system 112, the processor in a service provider device 106, the processor in the requester device 108, or any combination thereof, can perform the operations in process 200.

At operation 202, the processor receives a transportation request comprising an origin location and a destination location. In some examples, the processor validates that the origin location and the destination location match a location parameter. For example, the navigation system 112 may only reduce the number of complex maneuvers for navigation in specific locations (e.g., cities) corresponding to a location parameter.

At operation 204, the processor determines a first shortest path from the origin location to the destination location. The first shortest path comprises a first plurality of maneuvers and a total path value. The plurality of maneuvers includes driving maneuvers such as right and left turns, U-turns, lane changes, or any other suitable driving maneuver. The geographic area is represented using a weighted graph, where the origin and destination locations are nodes in the graph and the roadways are edges in the graph. The total path value is the sum of the weight of the traversed edges in the first shortest path.

At operation 206, the processor identifies a subset of maneuvers from the first plurality of maneuvers that are each associated with a penalty parameter and a penalty value. In some examples, the identified subset of maneuvers is retrieved from a database of maneuvers that includes data associated with maneuvers indicating maneuvers that are associated with a penalty parameter. The penalty parameter can be a flag that indicates that a maneuver is a complex maneuver. This data can be generated from user annotations or feedback, from historical data, based on a type of maneuver, or other means. For example, a user of the navigation system 112 can manually annotate specific maneuvers to indicate that the specific maneuvers are complex maneuvers, and the navigation system stores the annotation data in a database. In some examples, the identified subset of maneuvers is identified using historical data. For example, the identified subset of maneuvers can be associated with historical negative user feedback data. Negative user feedback data can indicate that a given maneuver is unsafe or difficult. The historical negative user feedback data may be manually received by a user or may be accessed from third-party databases. In some examples, the identified subset of maneuvers is identified using a statistical model the predicts the likelihood that a specific maneuver will be associated with negative user feedback data and thus be categorized as a complex maneuver, based on the historical negative user feedback data.

In some examples, the penalty parameter is associated with a complex maneuver type. For example, certain complex maneuver types are flagged with a penalty parameter based on how difficult or unsafe the maneuver is for navigation. For instance, complex maneuver types that are assigned a penalty parameter include unprotected left turns, U-turns on major, high-traffic roads, a sequence of maneuvers such as a left turn followed by an immediate right, and two consecutive left turns on major, high-traffic roads, and the like. In some examples, the penalty value is based on the difficulty of the maneuver. For example, an unprotected left turn can have a higher penalty value than a U-turn maneuver. In some examples, the penalty value is further based on the location parameter. For example, based on the specific location, certain maneuvers are less favorable. In some examples, the penalty value is a constant value for all complex maneuver types. In some examples, the penalty value is a constant value for non-consecutive complex maneuvers (e.g., same penalty value for unprotected left turn, left turn on a major, high-traffic road, and U-turn) but the penalty value is based on a specific location for specific sequences of maneuvers (e.g., the penalty value for a left turn followed by immediate right turn in New York City is higher than in Austin, Texas). In some examples, the identified subset of maneuvers are consecutive maneuvers, non-consecutive maneuvers, or any combination thereof.

At operation 208, the processor generates a modified total path value by applying the penalty value to each of the identified subset of maneuvers. For example, the processor recalculates the sum of the weights of the traversed edges in the first shortest path after modifying the weights of the edges associated with the identified subset of maneuvers based on the penalty values. The processor determines whether the modified total path value exceeds a threshold value. If the processor determine that the modified total path value does not exceed the threshold value, the processor provides navigation instructions associated with the first plurality of maneuvers to a computing device.

At operation 210, in response to identifying that the modified total path value exceeds a threshold value, the processor determines a second shortest path from the origin location to the destination location. The threshold value may be any predefined numerical value that indicates the safety and ease of the navigation. For example, if the modified total path value is too high and exceeds the threshold value, this indicates that the route includes too many complex maneuvers and thus would be an unsafe or difficult navigation. As a result, the processor would aim to determine a second shortest path that has fewer complex maneuvers. The second shortest path may be determined by identifying a shortest path between the origin and destination locations using the updated weights of the impacted edges as per operation 208. The second shortest path may have fewer complex maneuvers than the first shortest path.

At operation 212, the processor generates navigation instructions comprising a second plurality of maneuvers associated with the second shortest path. The second plurality of maneuvers includes fewer complex maneuvers than the first plurality of maneuvers. At operation 214, the processor transmits the navigation instructions to a computing device. For example, the navigation instructions are transmitted to any one of the service provider device 106 and the requester device 108. In some examples, the processor may further generate a notification that the navigation instructions contain fewer complex maneuvers. The notification may be presented on a user interface of the service provider device 106 and the requester device 108.

FIG. 3 is a diagrammatic representation of the machine 300 within which instructions 302 (e.g., software, a program, an application, an applet, an app, or other executable code) for causing the machine 300 to perform any one or more of the methodologies discussed herein may be executed. For example, the instructions 302 may cause the machine 300 to execute any one or more of the methods described herein. The instructions 302 transform the general, non-programmed machine 300 into a particular machine 300 programmed to carry out the described and illustrated functions in the manner described. The machine 300 may operate as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 302, sequentially or otherwise, that specify actions to be taken by the machine 300. Further, while a single machine 300 is illustrated, the term “machine” shall also be taken to include a collection of machines that individually or jointly execute the instructions 302 to perform any one or more of the methodologies discussed herein. The machine 300, for example, may comprise the user system 102 or any one of multiple server devices forming part of the network system 102. In some examples, the machine 300 may also comprise both client and server systems, with certain operations of a particular method or algorithm being performed on the server-side and with certain operations of the particular method or algorithm being performed on the client-side.

The machine 300 may include processors 304, memory 306, and input/output I/O components 308, which may be configured to communicate with each other via a bus 310. In an example, the processors 304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 312 and a processor 314 that execute the instructions 302. The term “processor” is intended to include multi-core processors that may comprise two or more independent processors (sometimes referred to as “cores”) that may execute instructions contemporaneously. Although FIG. 3 shows multiple processors 304, the machine 300 may include a single processor with a single-core, a single processor with multiple cores (e.g., a multi-core processor), multiple processors with a single core, multiple processors with multiples cores, or any combination thereof.

The memory 306 includes a main memory 316, a static memory 318, and a storage unit 320, both accessible to the processors 304 via the bus 310. The main memory 306, the static memory 318, and storage unit 320 store the instructions 302 embodying any one or more of the methodologies or functions described herein. The instructions 302 may also reside, completely or partially, within the main memory 316, within the static memory 318, within machine-readable medium 322 within the storage unit 320, within at least one of the processors 304 (e.g., within the processor's cache memory), or any suitable combination thereof, during execution thereof by the machine 300.

The I/O components 308 may include a wide variety of components to receive input, provide output, produce output, transmit information, exchange information, capture measurements, and so on. The specific I/O components 308 that are included in a particular machine will depend on the type of machine. For example, portable machines such as mobile phones may include a touch input device or other such input mechanisms, while a headless server machine will likely not include such a touch input device. It will be appreciated that the I/O components 308 may include many other components that are not shown in FIG. 3. In various examples, the I/O components 308 may include user output components 324 and user input components 326. The user output components 324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 308 may include biometric components 328, motion components 330, environmental components 332, or position components 334, among a wide array of other components. For example, the biometric components 328 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 330 include acceleration sensor components (e.g., accelerometer), gravitation sensor components, rotation sensor components (e.g., gyroscope).

The environmental components 332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 3600 camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 334 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 308 further include communication components 336 operable to couple the machine 300 to a network 338 or devices 340 via respective coupling or connections. For example, the communication components 336 may include a network interface component or another suitable device to interface with the network 338. In further examples, the communication components 336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 340 may be another machine or any of a wide variety of peripheral devices (e.g., a peripheral device coupled via a USB).

Moreover, the communication components 336 may detect identifiers or include components operable to detect identifiers. For example, the communication components 336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 336, such as location via Internet Protocol (IP) geolocation, location via Wi-Fi® signal triangulation, location via detecting an NFC beacon signal that may indicate a particular location, and so forth.

The various memories (e.g., main memory 316, static memory 318, and memory of the processors 304) and storage unit 320 may store one or more sets of instructions and data structures (e.g., software) embodying or used by any one or more of the methodologies or functions described herein. These instructions (e.g., the instructions 302), when executed by processors 304, cause various operations to implement the disclosed examples.

The instructions 302 may be transmitted or received over the network 338, using a transmission medium, via a network interface device (e.g., a network interface component included in the communication components 336) and using any one of several well-known transfer protocols (e.g., hypertext transfer protocol (HTTP)). Similarly, the instructions 302 may be transmitted or received using a transmission medium via a coupling (e.g., a peer-to-peer coupling) to the devices 340.

### Software Architecture

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematic functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which may be specific to a particular operating system or platform.

In an example, the applications 418 may include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

### EXAMPLES

Example 1 is a method including receiving a transportation request comprising an origin location and a destination location, determining a first shortest path from the origin location to the destination location, the first shortest path comprising a first plurality of maneuvers and a total path value, identifying a subset of maneuvers from the first plurality of maneuvers, that are each associated with a penalty parameter and a penalty value, generating a modified total path value by applying the penalty value to each of the identified subset of maneuvers, in response to identifying that the modified total path value exceeds a threshold value, determining a second shortest path from the origin location to the destination location, generating navigation instructions comprising a second plurality of maneuvers associated with the second shortest path, and transmitting the navigation instructions to a computing device.

In Example 2, the subject matter of Example 1 including wherein receiving the transportation request further comprises validating that the destination location and the origin location match a location parameter.

In Example 3, the subject matter of Examples 1-2 including wherein the penalty parameter is associated with a complex maneuver type.

In Example 4, the subject matter of Examples 1-3 including wherein the penalty value is based on a difficulty of the maneuver.

In Example 5, the subject matter of Examples 1-4 including wherein the penalty value is further based on the location parameter.

In Example 6, the subject matter of Examples 1-5 including wherein the identified subset of maneuvers is retrieved from a database of maneuvers.

In Example 7, the subject matter of Examples 1-6 including wherein the identified subset of maneuvers is identified using a statistical model trained on historical user feedback data.

In Example 8, the subject matter of Examples 1-7 including wherein the total path value is an aggregation of path values associated with the first plurality of maneuvers.

In Example 9, the subject matter of Examples 1-8 including wherein the identified subset of maneuvers are consecutive maneuvers.

Example 10 is a system comprising means to implement of any of Examples 1-9.

Example 11 is a non-transitory computer readable medium to implement of any of Examples 1-9.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A method comprising:
receiving a transportation request comprising an origin location and a destination location;
determining a first shortest path from the origin location to the destination location, the first shortest path comprising a first plurality of maneuvers and a total path value;
identifying a subset of maneuvers from the first plurality of maneuvers that are each associated with a penalty parameter and a penalty value;
generating a modified total path value by applying the penalty value to each of the identified subset of maneuvers;
in response to identifying that the modified total path value exceeds a threshold value, determining a second shortest path from the origin location to the destination location;
generating navigation instructions comprising a second plurality of maneuvers associated with the second shortest path; and
transmitting the navigation instructions to a computing device.

2. The method of claim 1, wherein receiving the transportation request further comprises:
validating that the destination location and the origin location match a location parameter; and
in response to the validation, generating the modified total path value.

3. The method of claim 2, wherein the penalty parameter is associated with a complex maneuver type.

4. The method of claim 3, wherein the penalty value is based on a difficulty of the maneuver.

5. The method of claim 3, wherein the penalty value is further based on the location parameter.

6. The method of claim 1, wherein the identified subset of maneuvers is retrieved from a database of maneuvers.

7. The method of claim 1, wherein the identified subset of maneuvers is identified using a statistical model trained on historical user feedback data.

8. The method of claim 1, wherein the total path value is an aggregation of path values associated with the first plurality of maneuvers.

9. The method of claim 1, wherein the identified subset of maneuvers are consecutive maneuvers.

10. A system comprising:
a processor; and
a memory storing instructions that, when executed by the processor, configure the system to perform operations comprising:
receiving a transportation request comprising an origin location and a destination location;
determining a first shortest path from the origin location to the destination location, the first shortest path comprising a first plurality of maneuvers and a total path value;
identifying a subset of maneuvers from the first plurality of maneuvers that are each associated with a penalty parameter and a penalty value;
generating a modified total path value by applying the penalty value to each of the identified subset of maneuvers;
in response to identifying that the modified total path value exceeds a threshold value, determining a second shortest path from the origin location to the destination location;
generating navigation instructions comprising a second plurality of maneuvers associated with the second shortest path; and
transmitting the navigation instructions to a computing device.

11. The system of claim 10, wherein receiving the transportation request further comprises:
validating that the destination location and the origin location match a location parameter.

12. The system of claim 11, wherein the penalty parameter is associated with a complex maneuver type.

13. The system of claim 12, wherein the penalty value is based on a difficulty of the maneuver.

14. The system of claim 12, wherein the penalty value is further based on the location parameter.

15. The system of claim 10, wherein the identified subset of maneuvers is retrieved from a database of maneuvers.

16. The system of claim 10, wherein the identified subset of maneuvers is identified using a statistical model trained on historical user feedback data.

17. The system of claim 10, wherein the total path value is an aggregation of path values associated with the first plurality of maneuvers.

18. The system of claim 10, wherein the identified subset of maneuvers are consecutive maneuvers.

19. A non-transitory computer-readable storage medium, the computer-readable storage medium including instructions that when executed by a computer, cause the computer to perform operations comprising:
receiving a transportation request comprising an origin location and a destination location;
determining a first shortest path from the origin location to the destination location, the first shortest path comprising a first plurality of maneuvers and a total path value;
identifying a subset of maneuvers from the first plurality of maneuvers that are each associated with a penalty parameter and a penalty value;
generating a modified total path value by applying the penalty value to each of the identified subset of maneuvers;
in response to identifying that the modified total path value exceeds a threshold value, determining a second shortest path from the origin location to the destination location;
generating navigation instructions comprising a second plurality of maneuvers associated with the second shortest path; and
transmitting the navigation instructions to a computing device.

20. The non-transitory computer-readable storage medium of claim 19, wherein the penalty parameter is associated with a complex maneuver type.
